(19) United States
(12) Patent Application Publication
(10) Pub. No.: US 2013/0179792 A1
(43) Pub. Date: Jul. 11, 2013

(54) System and Method for National Field Condition Reporting

(71) Applicant: PASSUR Aerospace, Inc., Stamford, CT (US)

(72) Inventors: Renee Johns ALTER, Stamford, CT (US); Thomas White, Huntington, NY (US); Robert Damis, Patchogue, NY (US); Ron Dunsky, Brooklyn, NY (US); Frederick Roe, New London, CT (US)

(73) Assignee: PASSUR Aerospace, Inc., Stamford, CT (US)

(21) Appl. No.: 13/731,423

(22) Filed: Dec. 31, 2012

Related U.S. Application Data
(60) Provisional application No. 61/581,411, filed on Dec. 29, 2011.

(51) Int. Cl. H04L 29/08

(52) U.S. Cl. CPC H04L 67/125
USPC 715/734

(57) ABSTRACT

A system, method and computer readable storage medium for receiving, by a server, update data for a plurality of airports from a respective remote server, the update data indicative of a status change of the respective airport and generating, by the server, a display including an airport icon for each of the airports, the airport icons including a respective visual indicator as a function of the update data.

### PRIORITY CLAIM/INCORPORATION BY REFERENCE

The present application claims priority to U.S. Provisional Patent Application 61/581,411 filed on Dec. 29, 2011 entitled “National Field Condition Reporting” naming Renee Johns Alter, Thomas White, Robert Damis, Ron Dunsky, and Frederick Roe as inventors, and hereby incorporates, by reference, the entire subject matter of this Provisional Application.

### BACKGROUND INFORMATION

An airport may experience various events that cause delays or other issues, thereby affecting scheduled operations. Accordingly, it is important for an airline to receive field condition report information such as NOTAM (Notice to Airmen) and non-NOTAM. NOTAM information may provide airlines and pilots with data relating to hazardous conditions en route of a flight or at a specific location. Non-NOTAM information may provide airlines and pilots with other data relating to non-hazardous conditions. By receiving this type of information (particularly in real time) from airports, airlines are able to address diversion management or other irregular operations such as extended tarmac delays and snow events. Airports and airlines may also request information about conditions in nearby airports (particularly airports that are part of a larger “metroplex” operation) to aid in addressing diversion management and the irregular operations.

Conventional systems allow an airport or airline to receive the information in an ad hoc manner in which particular location or airport data is received upon request. However, there is currently no system that allows the airport or airline to view the relevant information on a national scale. Furthermore, smaller “outstation” airports where staffing is minimal may have difficulty in providing their conditions or provide updates in field condition changes. Although NOTAM information may be readily available, non-NOTAM information may be hard to provide, if even provided in the first place.

Thus, there is a need for a national field condition reporting (FCR) platform that provides NOTAM and non-NOTAM information on a national scale for airports in real time.

### SUMMARY OF THE INVENTION

A method for receiving, by a server, update data for a plurality of airports from a respective remote server, the update data indicative of a status change of the respective airport and generating, by the server, a display including an airport icon for each of the airports, the airport icons including a respective visual indicator as a function of the update data.

A system having a plurality of remote servers for a respective airport generating respective update data for the respective airport, the update data indicative of a status change of the respective airport and a server receiving the update data and generating a display including an airport icon for each of the airports, the airport icons including a respective visual indicator as a function of the update data.

A non-transitory computer readable storage medium storing a set of instructions that are executable by a processor. The instructions causing the processor to receive update data for a plurality of airports from a respective remote server, the update data indicative of a status change of the respective airport and generate a display including an airport icon for each of the airports, the airport icons including a respective visual indicator as a function of the update data.

### BRIEF DESCRIPTION OF THE DRAWINGS

FIG. 1 shows a system for providing a national FCR platform according to the exemplary embodiments.

FIG. 2A shows a first view of a national FCR display according to the exemplary embodiments.

FIG. 2B shows a second view of a national FCR display according to the exemplary embodiments.

FIG. 2C shows a third view of a national FCR display according to the exemplary embodiments.

FIG. 2D shows a fourth view of a national FCR display according to the exemplary embodiments.

FIG. 3 shows a method of providing a national FCR platform according to the exemplary embodiments.

### DETAILED DESCRIPTION

The exemplary embodiments may be further understood with reference to the following description of the exemplary embodiments and the related appended drawings, wherein like elements are provided with the same reference numerals. The exemplary embodiments are related to a system and method of providing a national FCR platform such that NOTAM and non-NOTAM information of airports in real time are readily accessible. Specifically, the national FCR platform provides a national FCR map display that is customizable relative to a user in which the real time NOTAM and non-NOTAM information is shown.

As anyone who as ever flown on an airplane will know, a flight may experience various events such as delays. The airline may attempt to compensate for these delays to return to the scheduled flight plan. In order to return to the scheduled flight plan, the airline requires information from airports regarding conditions or other relevant data that may affect the schedule for the airline. The airline may also require information regarding hazardous conditions (NOTAM information) so that the airline may provide a pilot with alterations to the scheduled flight. For example, if a destination airport has experienced a hazardous event or has hazardous landing conditions, the airplane may be directed to land at a nearby airport. The airline will therefore also require information regarding the nearby airport.

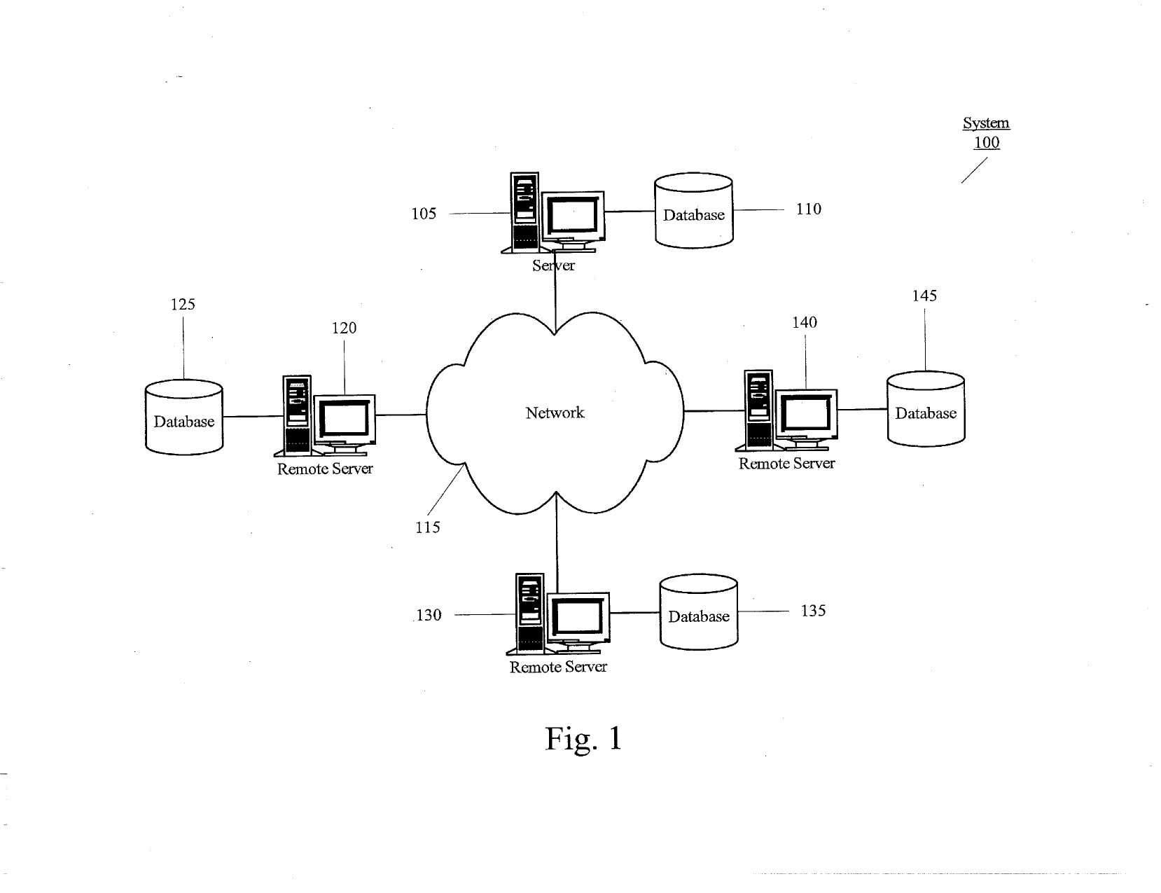

FIG. 1 shows a system 100 for providing a national FCR platform according to the exemplary embodiments. The national FCR platform may provide a single national standard that shows NOTAM and non-NOTAM information for airports of a particular country such as the United States. The national FCR platform may provide a display that shows the NOTAM and non-NOTAM information to a user. The national FCR platform may receive inputs that customize the display relative to the user. Accordingly, the national FCR platform may allow the user to access all information regarding airports on a national level from a single source. The system 100 may include a server 105 having a database 110 that receives information through a network 115 from a plurality of remote servers 120, 130, 140 each having a respective database 125, 135, 145.

The server 105 may provide the national FCR platform to the users. In a specific exemplary embodiment, the server 105 may provide a website accessible to the users such that information is displayed. The website may allow the users to customize the display as well as access the various types of information available thereon. The server 105 may retrieve data stored in the database 110 to update the display of the website. Furthermore, the server 105 may receive the information from the remote servers 120, 130, 140, store the information in the database, and update the display of the website as a function of the received information.

The remote server 120 may be a server for hazardous conditions related to airports. Accordingly, the remote server 120 may generate NOTAM information related to airports. The remote server 120 relating to NOTAM information may generate and transmit the hazardous condition information. Thus, the remote server 120 may relate to a government agency and/or an airport operator that generates the NOTAM information under guidelines specified by Annex 15: Aeronautical Information Services of the Convention on International Civil Aviation (CICA). As such, the NOTAM information is filed with an aviation authority to alert aircraft pilots of any hazards en route or at a specific location. The authority in turn provides a means of disseminating relevant NOTAM information to pilots. According to the exemplary embodiments, the remote server 120 may further provide the NOTAM information to the server 105 to update the national FCR platform display. As discussed above, the NOTAM information may relate to hazardous conditions for flights en route or at a specific location. For example, for hazardous conditions for flights en route, the NOTAM information may be weather conditions that should be avoided by an airplane. In another example, for hazardous conditions at a specific location, the NOTAM information may be a crash that occurred at an airport.

The remote servers 130, 140 may be servers for individual airports. The remote servers 130, 140 may generate non-NOTAM information related to the respective airport. As discussed above, the non-NOTAM information may be for information related to non-hazardous conditions. For example, the non-NOTAM information may be for an irregular operation at the airport such as an extended tarmac delay where an excessive number of airplanes are attempting to land at a congested tarmac. In another example, the non-NOTAM information may be for an excessive number of airplanes attempting to leave from the airport that causes a congestion and delay in take-off times. An administrator of the remote servers 130, 140 may enter real time updates such that the information is provided to the server 105 so that the national FCR platform display may be updated accordingly. In the conventional system, the remote servers 130, 140 show content updates such that when the user accesses the specific website for the airport, the information may be retrieved. However, according to the exemplary embodiments, the information may be received by the server 105 to show on an overall display.

The network 115 may be any network that allows data to be transmitted therethrough from a first end point to a second end point. Specifically, according to the exemplary embodiments, the network 115 may allow data from the remote servers 120, 130, 140 to be transmitted therethrough to the server 105. The server 105 may also transmit an acknowledgement that the updates provided by the remote servers 120, 130, 140 have been received via the network 115. The network 115 may be any configuration. For example, the network 115 may be the Internet. In another example, the network 115 may be a proprietary or private network in which authorized servers are only allowed to transmit data therethrough.

It should be noted that the use of two remote servers 130, 140 is only exemplary. Those skilled in the art will understand that for the national FCR platform according to the exemplary embodiments, there may be a remote server for each airport in the nation. That is, each airport that participates or operates may include a respective remote server that provides the non-NOTAM information to the server 105. Thus, the remote servers 130, 140 may represent each of the remote servers of every airport that is shown in the national FCR platform display.

It should also be noted that the server 105 may receive the airport data from the remote servers 120, 130, 140 in a variety of manners. In a first example, the server 105 may automatically receive any content updates from the remote servers 120, 130, 140 upon the administrator of respective remote server entering a content update. In a second example, the server 105 may periodically query the remote servers 120, 130, 140 with a request for content updates if available. In a third example, the remote servers 120, 130, 140 may manually push or transmit the content updates to the server 105.

As discussed above, the server 105 may provide a national FCR display to the users that access the information therein. The server 105 may receive authorization data so that the users are allowed to access the NOTAM and non-NOTAM information shown in the national FCR display. An authorized user list as well as associated authorization inputs may be stored, for example, in the database 110. As will be discussed in further detail below, the national FCR display may be customized for each user. Thus, when the user logs into the system, the customization for the user may update the view of the national FCR display. The customizations may be stored, for example, in the database 110.

It should be noted that the use of authorized users is only exemplary. The national FCR display may also be configured to be accessed by anyone. In such an embodiment, the national FCR display may be shown with a default setting. That is, the national FCR display may be shown with no customizations.

The national FCR display may provide a single national standard with information for each and every airport within the nation. It should be noted that the national FCR display may also be configured to provide information for select airports such as the busiest airports. The national FCR display minimizes a need to go to any other source or website to receive the requested information. Thus, any and all critical information is available through the national FCR display in some format. In particular, runway status changes and updates may be accessible on the national FCR display. Utilizing a national FCR map page, the national FCR display may illustrate the nation as a whole with information for each airport. As will be described in further detail below, the nation may be the United States in which the national FCR display may show the continental United States. However, it should be noted that other states such as Hawaii and Alaska may also be shown in, for example, insets.

The national FCR display enables users to glean the most important information about airports with a minimal amount of effort from the user through a system of onscreen alerts to content updates. Furthermore, the customization of the national FCR display allows the users to view this information of airports that are of concern to the user. Thus, the national FCR display reduces or eliminates a need for users to access subsequent displays (e.g., click to retrieve information on specific locations).

As will be discussed in further detail below, the national FCR display may include a user interface to select airports and content updates that drive the alerts. Prior to any customization by the user, default alert states may be displayed. The national FCR display may pull content updates and alerts from multiple locations on the individual source airport FCR pages including a new free form text content area specifically designated for the national FCR display that is generated by the airport operator (e.g., administrator of the remote servers 120, 130, 140). Accordingly, users may be alerted on the national FCR display of various content such as updates at airports and for content that is of concern to the user or messages conveyed by the airport about airport statuses through a visual indicator (e.g., color code) attached to the free form text box content.

Providing the above described features and functionalities of the national FCR display, airlines may realize a default single platform for all critical airport updates from a single source presented in a standardized format. Utilizing a national FCR data feed for airline systems, all airports across the nation may subscribe to this standard information format for year round use by the airlines.

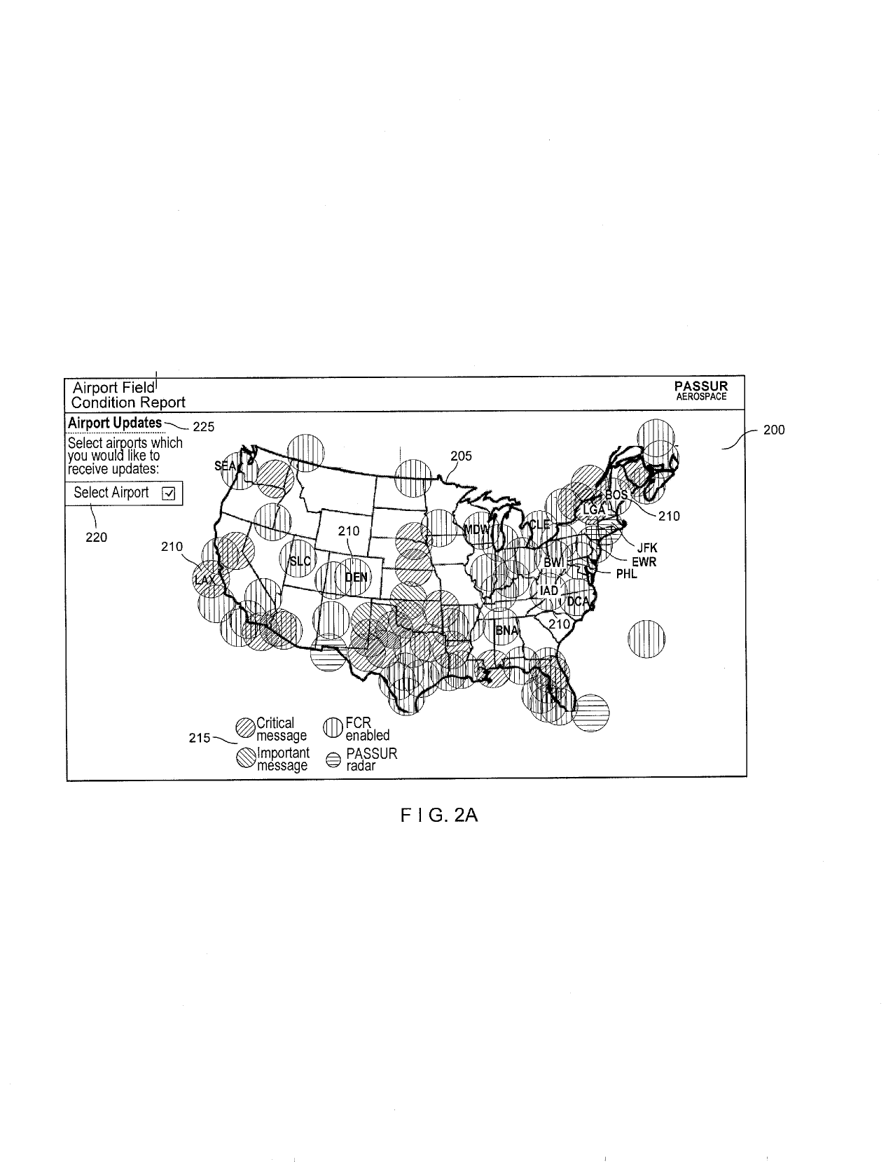

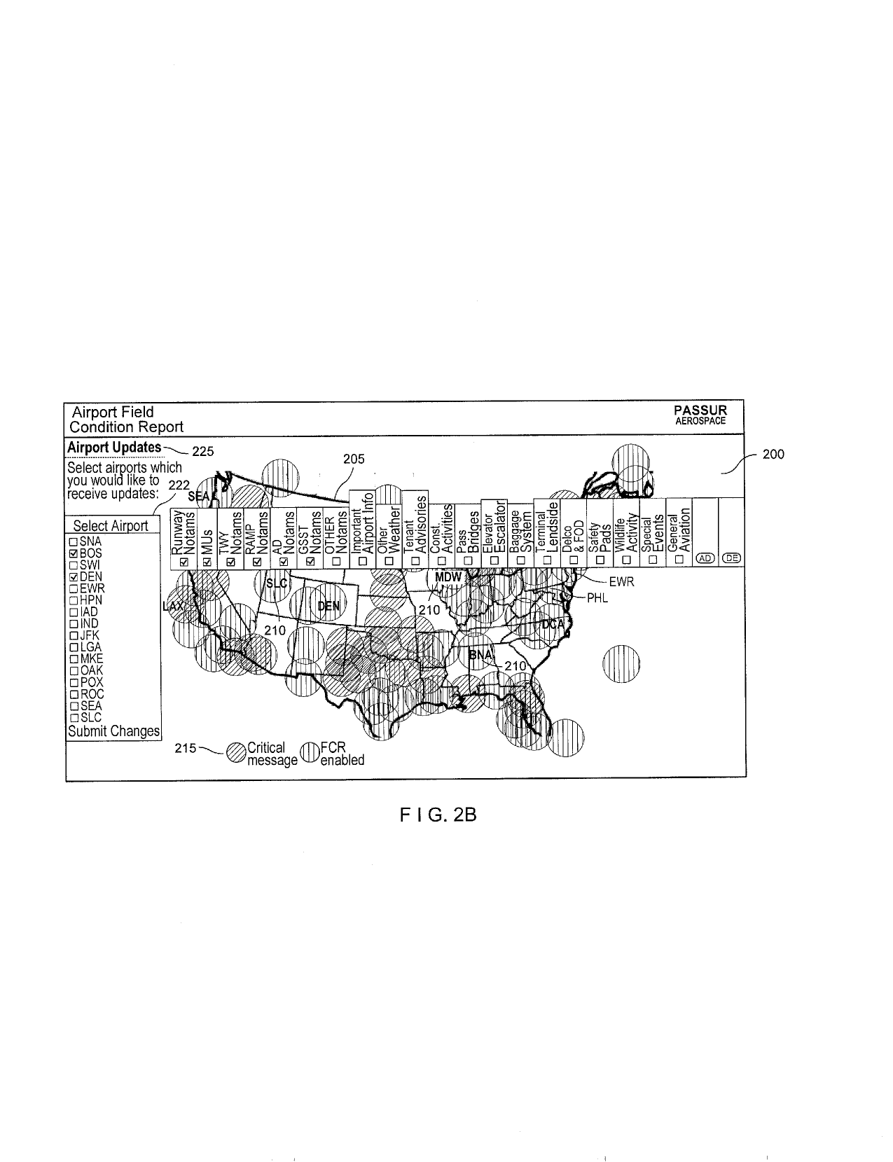

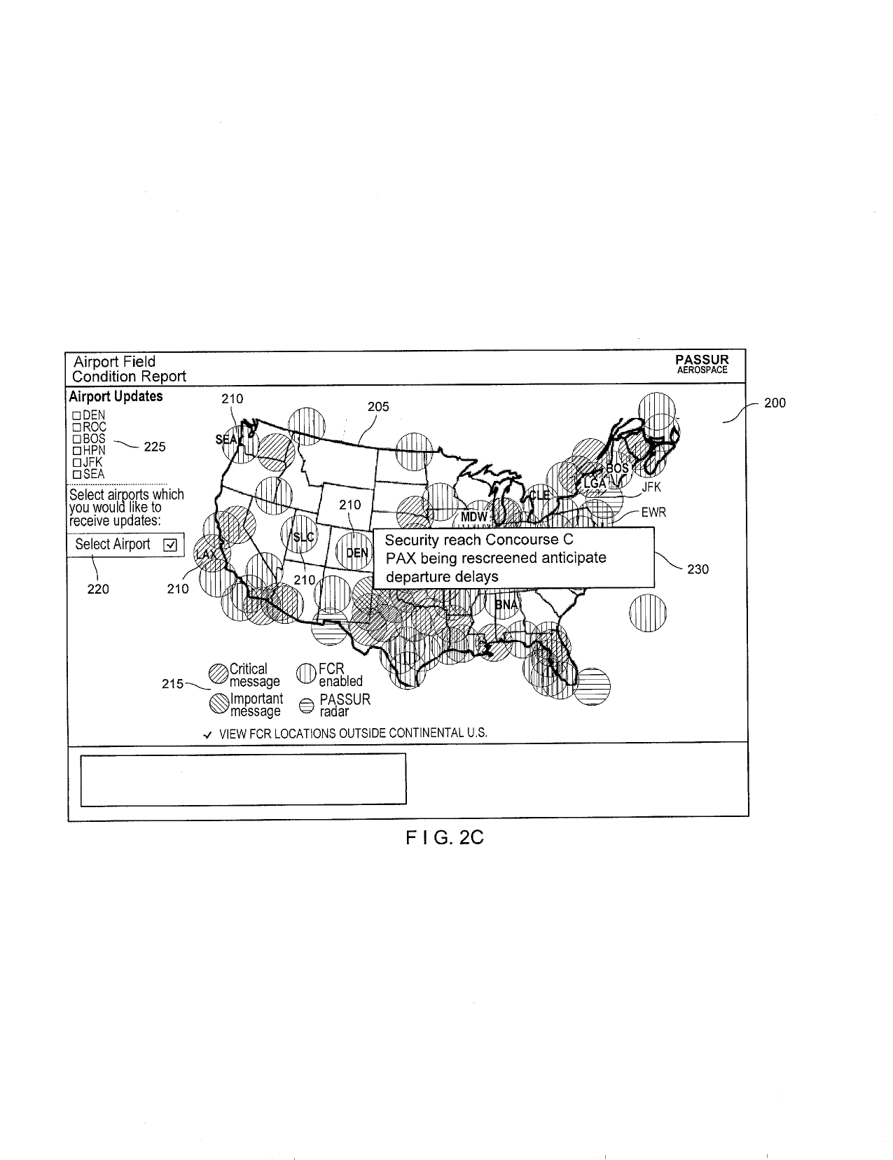

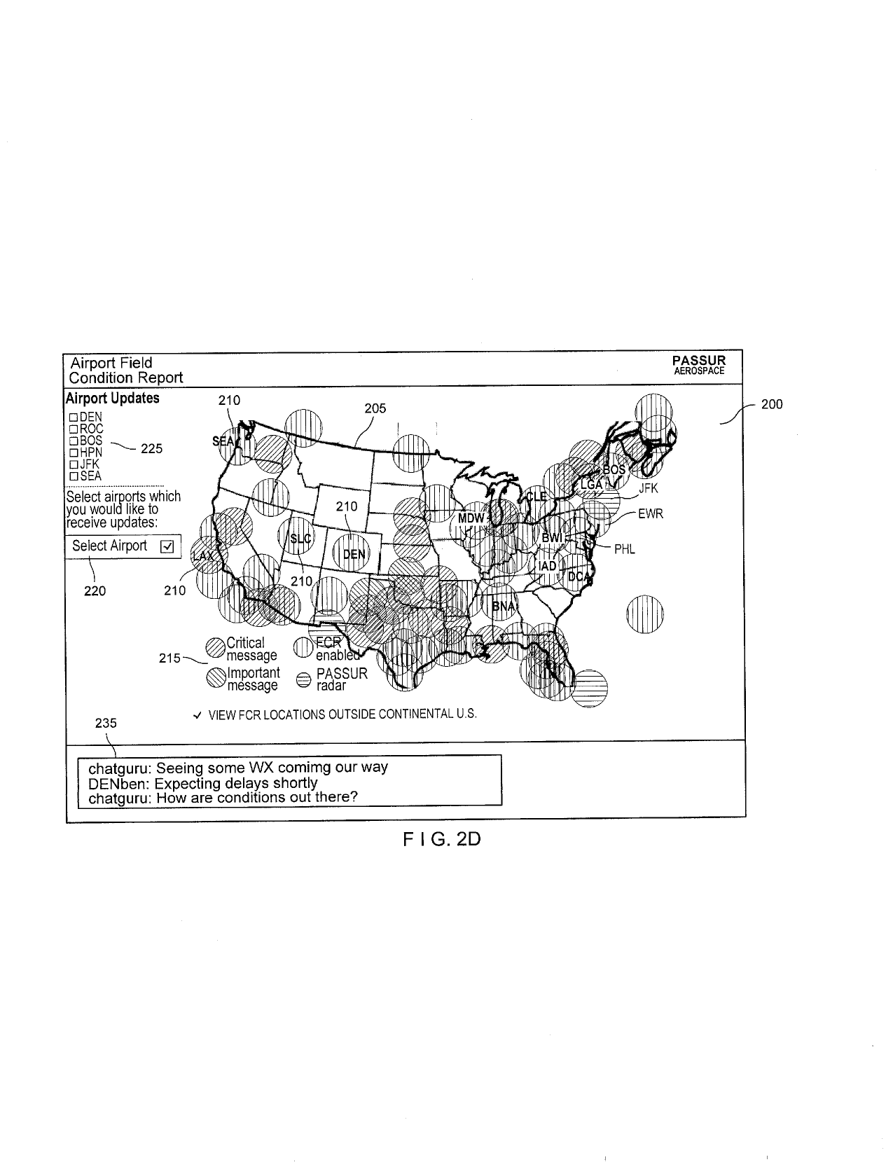

FIG. 2A shows a first view of a national FCR display 200 according to the exemplary embodiments. The first view of the national FCR display 200 may be a “home” screen shown to the user. The first view of the national FCR display 200 may also relate to a default view in which no customizations are entered or shown to an unsubscribed visitor.

The server 105 may receive information about the airports relating to NOTAM and non-NOTAM data from the remote servers 120, 130, 140. From the information that is received, the server 105 may generate an initial national FCR display 200 such as shown in FIG. 2A. The first view of the national FCR display 200 may include a variety of different information. For example, a map 205 including the continental United States may be shown. Airports 210 may also be shown within the map 205 including the airport code and a zone related to the airport (e.g., conditions for the airport). A legend 215 may be provided to allow the user to interpret the data shown in the national FCR display 200. As will be described in further detail below, a selector 220 may be used to customize the national FCR display 200 and an update window 225 may provide updates or changes to the airports 210 in the national FCR display 200.

As shown in the first view of the national FCR display 200 of FIG. 2A, the presentation of airport update information may show at least two levels of information alert for the user upon visiting the website. In a first level, visual indicia such as color-coding may be connected to the airport dot/airport code identifier on the map 205. The color-coding may reflect specific choices by the airport operator in populating the free form national FCR message box and selecting a level of alert associated with a particular color. For example, a green dot with the airport code therein may indicate that the airport is operating at optimal efficiency or no alerts currently exist. In another example, a yellow dot with the airport code therein may indicate that the airport is experiencing events (e.g., delays, weather conditions, etc.) that may affect the schedules for the airlines. In yet another example, a red dot with the airport code therein may indicate that the airport has experienced a major event or is experiencing significant delays or weather conditions that may drastically affect the schedules for the airlines. In a second level, a list of airports separate from the color coding and shown in the update window 225 may show updates for each selected airport that is customized by the user. As a customization, this may be an optional added level of alert for the user. The update window 225 will be discussed in further detail below with regard to FIG. 2B.

FIG. 2B shows a second view of the national FCR display 200 according to the exemplary embodiments. The second view of the national FCR display 200 shows the selector 220 being used such that a selector menu 222 is opened. The selector menu 222 allows the customization for the user by entering inputs for various selected airports and other information that is to be specifically highlighted for the user. In this manner, upon entering the selected airports, the update window 225 may show the highlighted information in a readily accessible manner for the user.

The national FCR display 200 may generate alerts to users that airports/content in their preference list have been updated. In a first exemplary embodiment, the administrator of the remote servers 120, 130, 140 may enter a message in a content area on its individual airport FCR page that is specifically designated as an update for the national FCR display 200. The administrator may enter the information such that the airport is flagged with a level of importance for display on both the individual FCR page for the airport and for the national FCR display 200. Furthermore, upon entering this message, the server 105 may be configured to determine the users who have selected the airport in which the message is entered and subsequently notify the users of the message (e.g., email, text message, phone call, etc.).

In addition, by receiving the message and the level of importance, the national FCR display 200 may be updated. For example, if the airport dot with the airport code therein is originally indicated with the color code of green, the event, message, and level of importance may be assessed to determine whether the color code should be changed. Thus, if the event/message/level of importance indicates that a major event has occurred at the airport, the national FCR display 200 may be updated such that the airport dot with the airport code therein is changed to a color code of red.

It should be noted that various other customizations may be made by the user for the updates and/or content display within the national FCR display 200. For example, the user may select to only show particular updates within the update window 225. Thus, if the airport dot has an update that requires a color code change to red, the update may automatically be shown in the update window 225. However, the user may select to also show updates that require a color code change to yellow. In another example, the user may select to have other forms of update visual indicia. As discussed above, the color code scheme may include three colors: red, yellow, green. The user may select to further include other colors in the color code scheme or the server 105 may include other color code schemes. For example, as discussed above, red may indicate a critical message from the airport while yellow may indicate an advisory message from the airport. The server 105 and/or the user may include other colors such as orange which indicates an important message from the airport.

The customization of the national FCR display 200 by the user may entail a variety of functions associated therewith. When a user logs into the system or provides other identification data that relates to the user, the user may be presented with a variety of different customization options. In a first example, the user may select from an airport list which airports will show alerts to content updates such as with the selector 220. In a second example, the user may select from a list of content areas updates to which alerts are driven to the national FCR display 200 via the selector menu 222. In a third example, there may be a default set of information that is displayed if the user selects to not customize the national FCR display 200. In a third example, if there are further content updates such as those discussed above, these content elements may be added to the user preference selection. In a fourth example, the user may select from a list of methods to being alerted such as a visual on the national FCR display 200, an audio output, communications methods (e.g., email, text, etc.), etc. As will be discussed in further detail below, the user may select which content updates are to be displayed but there may be exemptions to this preference selection.

As a result of the customization from the user, the display of alerts and information may be set in the process such that changes/updates in any of the selected content or default content is altered. In a first example, the color coded updates may change the color of the airport dot with the airport code therein, thereby reflecting either one of the colors selected by the airport administrator using the free form text box or a color that indicates that there is an update of some kind. In a second example, a list of airports that represent all facilities that have an update, thereby reflecting the list of airports selected in the user preferences or a default list if no selections are made (e.g., all airports with updates). In a third example, a visual indicator such as a text box may be displayed when the user selects an airport 210 on the map 205. For example, if the user mouses over the airport 210, the text box (e.g., pop-up box) may be generated that includes content updates or the message entered by the airport administrator. The text box may also be generated when the user selects an airport from the update window 225.

It should be noted that the national FCR display 200 may be configured with other settings. For example, the user may have already accessed the content updates for a particular airport 210. The server 105 may determine when the content update has been accessed or viewed, thereby having a reset effect of the alert state. When this occurs, the server 105 may provide different visual indicia to indicate to the user that the content update has already been viewed or that other content updates are available for the airport.

FIG. 2C shows a third view of the national FCR display 200 according to the exemplary embodiments. As discussed above, the national FCR display 200 may include feature that generates a text box for a selected airport. As shown in the third view of the national FCR display 200 of FIG. 2C, the text box 230 may be generated by the server 105 when the airport 210 is selected. Specifically, the airport dot with the airport code may be for the Denver, Colo. airport. The airport dot may have had a color change such that the color code is red. When the user mouses over the airport 210, the text box 230 may be shown to the user that includes the content update such as the message from the administrator of the remote server for the Denver airport.

FIG. 2D shows a fourth view of the national FCR display 200 according to the exemplary embodiments. As shown in the fourth view of the national FCR display 200, a real time display 235 may be shown. The real time display 235 may show various content updates for the airports 210. As discussed above, the real time display 235 may automatically show all updates for the airports 210 despite the update relating to an airport that is not selected by the user. The real time display 235 may also enable a chat feature as described below.

It should be noted that the national FCR display 200 may show other types of data and/or receive other data from different sources. For example, a database or application universe may generate content/updates for the national FCR display 200. The databases or application universe may provide different forms of data to the user. The different forms may include current versus historical airport efficiency rates, current diversion saturation statuses, current arrival/departure rates, current runway configurations, etc.

It should also be noted that the server 105 and/or the national FCR display 200 may include further options to be included within the national FCR display 200. In a first example, the national FCR display 200 may integrate FAA (Federal Aviation Administration) Air Traffic Delays Statuses. In the context of the national FCR display 200, a square icon may be placed next to the airport 210 for this information. In a second example, the national FCR display 200 may include a pan/zoom feature. For example, in the northeast, the icons for the airports therein may overlap or are difficult for the user to properly select. Thus, by zooming into the map 205, the airports 210 may be separated sufficiently for the user to properly select the correct airport 210. In a third example, a scrolling message board may be shown to allow the administrator of the server 105 to display messages to the users. In a fourth example, the national FCR display 200 may show a list of users who are logged into the system. In a traditional chat room manner, the users may be able to see who is currently logged into the system. Thus, the system may further incorporate a chat feature such that the users are able to send instant messages to other logged in users.

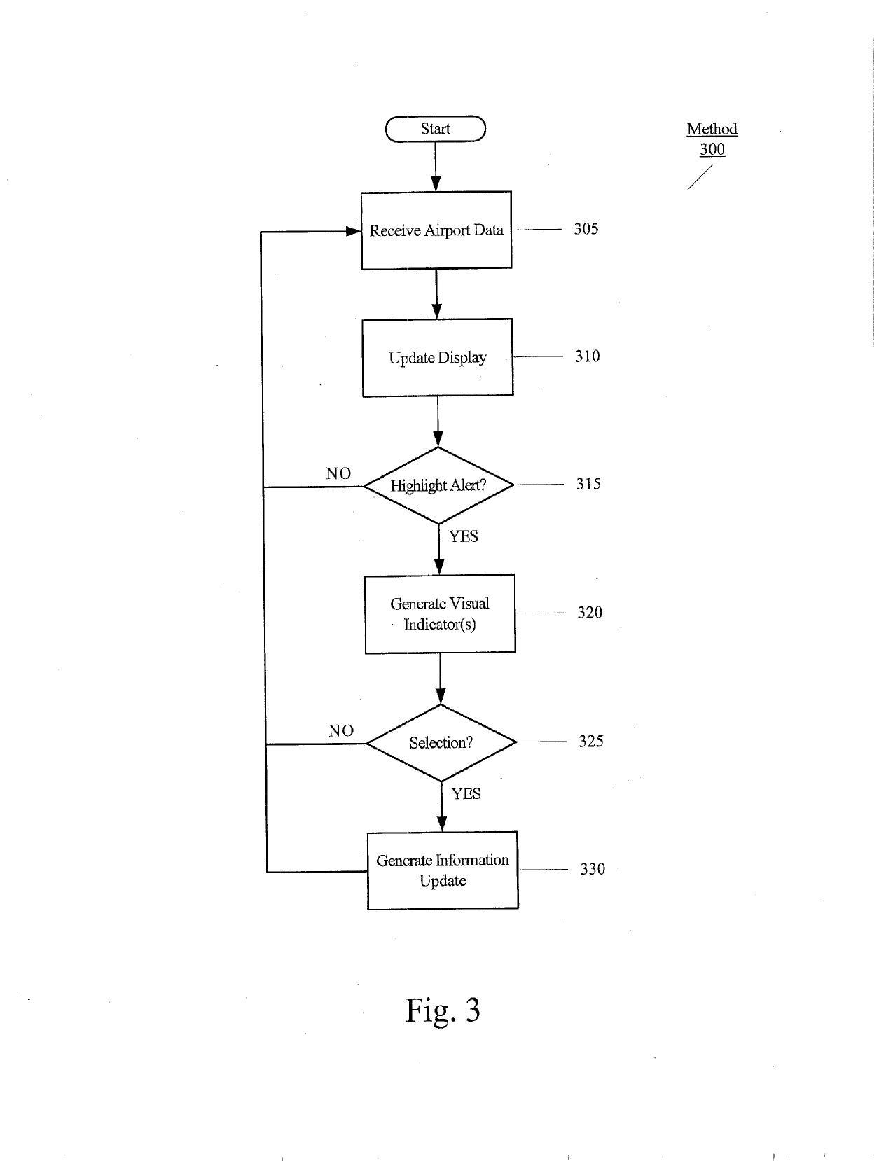

FIG. 3 shows a method 300 of providing a national FCR platform according to the exemplary embodiments. As discussed above, the national FCR display 200 may provide the user with various content updates for the airports 210 in the map 205 or for selected airports from the customization of the user via the selector 220 and the selector menu 222. The method 300 will be described with reference to the system 100 of FIG. 1 and the views of the national FCR display 200 of FIGS. 2A-2D.

In step 305, the server 105 receives the airport data from the remote servers 120, 130, 140. As discussed above, the remote server 120 may provide NOTAM information while the remote servers 130, 140 may provide non-NOTAM information. Thus, the server 105 may receive hazardous related information and non-hazardous related information for the airports 210. Upon receiving the airport data, in step 310, the server 105 may update the national FCR display 200 as a function of the airport data.

In step 315, a determination is made whether an alert is to be highlighted. In a first example as discussed above, the user may provide customization input data for select airports and further include particular types of update/content to be displayed for the select airports. The server 105 may determine which airports 210 include content updates for the user's customization. In a second example as discussed above, default settings may be used for the national FCR display 200. As such, the alerts may be highlighted for predetermined types of content updates. For example, only color code of red updates may be highlighted in the national FCR display 200.

If the determination from step 315 does not require any alerts to be highlighted, the method 300 returns to step 305 where the server 105 continues to receive airport data from the remote servers 120, 130, 140. If the determination from step 315 requires alerts to be highlighted, the method 300 continues to step 320. In step 320, the visual indicators are generated as a function of the airport data. For example, if an airport 210 includes a critical message, the airport dot including the airport code therein may change its color code accordingly. In another example, if a selected airport includes content updates, the update window 225 may be updated to include the airport. In yet another example, messages entered by the administrators of the remote servers may be displayed in the real time display 235.

In step 325, a determination is made whether a selection of an airport is made by the user. As discussed above, the user may mouse over an airport 210 on the map 205 or may mouse over an airport listed in the update window 225. If no selection is made, the method 300 returns to step 305 where the server 105 continues to receive airport data. If a selection is made, the method 300 continues to step 330. In step 330, an information update is generated. As discussed above, when the user selects an airport 210 on the map 205 or selects an airport in the update window 225, a text box such as a pop-up box may be generated by the server 105. The text box may include the message entered by the administrator of the remote server or may include content update related to the selected airport.

It should be noted that the method 300 may include other steps. For example, after step 310 or step 320, the user may be allowed to provide customization input data. Specifically, the user may utilize the selector 220 to select airports 210. Subsequently, the selector menu 222 may be used to further select the particular types of content updates to be displayed. Thus, as a function of this selection, the server 105 may determine whether alerts are to be highlighted in step 315 or whether visual indicators or information updates are to be provided.

The exemplary embodiments provide a national FCR platform that in which a single national standard is utilized to provide a national FCR display to users. Information relating to airports such as NOTAM and non-NOTAM data may be shown in the national FCR display. The national FCR display provides a one-stop source for all pertinent information of airports to the user. Accordingly, the user is not required to visit other sources for the airport data. The national FCR display may be customized according to the user's preferences such that selected data may be shown to the user.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Mac platform and MAC OS, etc. In a further example, the exemplary embodiments of the national FCR platform may be a program containing lines of code stored on a non-transitory computer readable storage medium that, when compiled, may be executed on a processor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalent.

What is claimed is:

1. A method, comprising:
receiving, by a server, update data for a plurality of airports from a respective remote server, the update data indicative of a status change of the respective airport; and
generating, by the server, a display including an airport icon for each of the airports, the airport icons including a respective visual indicator as a function of the update data.

2. The method of claim 1, further comprising:
receiving, by the server, further update data for the airports; and
generating, by the server, a further display including the airport icons, the airport icons including an updated visual indicator as a function of the further update data.

3. The method of claim 1, further comprising:
receiving a selection of one of the airports; and
generating, by the server, a text box including the update data for the one of the airports.

4. The method of claim 1, further comprising:
receiving at least one customization input data, the customization input data indicative of at least one selection of the airports and at least one type of the update data.

5. The method of claim 4, wherein the display is generated as a function of the at least one customization input data.

6. The method of claim 4, further comprising:
generating, by the server, an update list shown within the display, the update list including the update data for each of the at least one selection of the airports.

7. The method of claim 1, further comprising:
generating, by the server, a real time display shown within the display, the real time display showing each of the status changes.

8. The method of claim 1, wherein the airport icons include a respective airport code displayed therein.

9. The method of claim 1, further comprising:
generating, by the server, a legend shown within the display, the legend defining each of the visual indicators.

10. The method of claim 1, wherein the update data is at least one of Notice to Airmen (NOTAM) data and non-NOTAM data.

11. A system, comprising:
a plurality of remote servers for a respective airport generating respective update data for the respective airport, the update data indicative of a status change of the respective airport; and
a server receiving the update data and generating a display including an airport icon for each of the airports, the airport icons including a respective visual indicator as a function of the update data.

12. The system of claim 11, wherein the server receives further update data for the airports and generates a further display including the airport icons, the airport icons including an updated visual indicator as a function of the further update data.

13. The system of claim 11, wherein the server receives a selection of one of the airports and generates a text box including the update data for the one of the airports.

14. The system of claim 11, wherein the server receives at least one customization input data, the customization input data indicative of at least one selection of the airports and at least one type of the update data.

15. The system of claim 14, wherein the server generates the display as a function of the at least one customization input data.

16. The system of claim 14, wherein the server generates an update list shown within the display, the update list including the update data for each of the at least one selection of the airports.

17. The system of claim 11, wherein the server generates a real time display shown within the display, the real time display showing each of the status changes.

18. The system of claim 11, wherein the airport icons include a respective airport code displayed therein.

19. The system of claim 11, wherein the server generates a legend shown within the display, the legend defining each of the visual indicators.

20. A non-transitory computer readable storage medium storing a set of instructions that are executable by a processor, the instructions causing the processor to:
receive update data for a plurality of airports from a respective remote server, the update data indicative of a status change of the respective airport; and
generate a display including an airport icon for each of the airports, the airport icons including a respective visual indicator as a function of the update data.
